(19) United States
(12) Patent Application Publication
(10) Pub. No.: US 2010/0023715 A1
(43) Pub. Date: Jan. 28, 2010

(54) SYSTEM FOR IMPROVING START OF DAY TIME AVAILABILITY AND/OR PERFORMANCE OF AN ARRAY CONTROLLER

(76) Inventors: Mahmoud K. Jibbe, Wichita, KS (US); Britto Rossario, Bangalore (IN); Prakash Palanisamy, Mettupalayam (IN)

Correspondence Address: CHRISTOPHER P MAIORANA, PC;LSI Corporation, 24840 HARPER, SUITE 100, ST CLAIR SHORES, MI, 48080, US

(21) Appl. No.: 12/178,064

(22) Filed: Jul. 23, 2008

(51) Int. Cl. G06F 12/16

(52) U.S. Cl. 711/162; 711/E12.103

(57) ABSTRACT

An apparatus comprising a storage array, a controller, a cache storage area and a backup storage area. The storage array may include a plurality of storage devices. The controller may be configured to send one or more commands configured to control reading and writing data to and from the storage array. The commands may include volume configuration information used by each of the plurality of storage devices. The cache storage area may be within the controller and may be configured to store a copy of the commands. The backup storage area may be configured to store the copy of the commands during a power failure.

### FIELD OF THE INVENTION

The present invention relates to storage arrays generally and, more particularly, to a method and/or apparatus for improving start of day time availability and/or performance of an array controller.

### BACKGROUND OF THE INVENTION

Conventional storage controllers take at least 50 seconds to finish a complete controller boot process. If a large number of volumes are implemented and/or a large number of features are used, a conventional controller may take more than 5 minutes to complete the boot process. Conventional controllers need to write array and/or volume configuration information to many drives, even for minor changes in the configuration.

The boot sequence in a RAID controller is often referred to as a Start of Day (SOD) Sequence. The Start of Day (or Boot) sequence is triggered for a number of reasons such as (i) Controller/Array power cycling, (ii) Controller/Array reboot, (iii) Controller/Array moving offline and online (for maintenance), (iv) Controller/Array being restarted by an alternate Controller/Array if a problem is detected. The Controller triggers for SOD/Boot sequence and the boot image is loaded from Flash/CFW (Controller Firmware) memory to a fixed main memory.

The following factors affect and increase the SOD/Boot sequence time (1) Controller/Array with maximum Volumes/LUNs mapped to host, (2) Controller/Array with premium features (like Snapshot, Volume Copy and Remote mirroring) enabled, (3) Controller/Array checking the faulty components and cache synchronizing/flushing, (4) Controller/Array trying to get the configuration data from hard disk drives (called DACstore (Disk Array Access Controller)) that is necessary for booting. These factors are a major block for boot time since the read/seek time with all the Hard Disk Drives is slow, especially when serving IO requests from an alternate controller.

Conventional controllers often have Cache supported by a smart battery backup unit and USB persistent storage to have persistent data about Major Event Logs and Cache data. In a conventional controller, when an event occurs that needs a DACStore update, the changes are written on all the drives attached to the controller. The writing process increases time and uses more drive effort.

Conventional DACStore information contains one or more of the following types of information (i) array configuration, (ii) volume configuration, (iii) volume groups and volumes in the array, (iv) table of volume group, (v) volumes and drive relation, (vi) LUN mapping information, (vii) metadata, and (viii) subsystem component failures. In a conventional system, DACStore information gets replicated to all the drives in the storage array, which is redundant. Replication of the DACStore information for minor changes increases overhead for the storage controller boot process and ends up increasing SOD timing.

Conventional approaches have a number of disadvantages. The more drive trays implemented, the more time needed to complete the Start of Day procedure. During the SOD procedure, there is a chance of losing access to all the drives that have meta data. Conventional approaches also have a number of the following disadvantages (i) adverse performance impact, (ii) long SOD timing for large configurations, (iii) long reconstruction time for the DACStore information, (iv) Internet Protocol (IP) conflicts during volume group migration, (v) premium feature hack threat with volume group migration, and (vi) stored updates writing DACStore on multiple drives for minor changes like IP configuration.

It would be desirable to implement a system for improving Start of Day time availability and/or performance of a storage array controller.

### SUMMARY OF THE INVENTION

The present invention concerns an apparatus comprising a storage array, a controller, a cache storage area and a backup storage area. The storage array may include a plurality of storage devices. The controller may be configured to send one or more commands configured to control reading and writing data to and from the storage array. The commands may include volume configuration information used by each of the plurality of storage devices. The cache storage area may be within the controller and may be configured to store a copy of the commands. The backup storage area may be configured to store the copy of the commands during a power failure.

The objects, features and advantages of the present invention include providing a system for improving Start of Day time availability in a controller that may (i) reduce redundancy, (ii) be easy to implement, (iii) increase performance of a frame array controller and/or (v) work with signals received from a battery backup unit.

### BRIEF DESCRIPTION OF THE DRAWINGS

These and other objects, features and advantages of the present invention will be apparent from the following detailed description and the appended claims and drawings in which:

FIG. 1 is a diagram illustrating a context of and embodiment of the present invention;

FIG. 2 is a block diagram of an embodiment of the present invention; and

FIG. 3 is a flow chart of an example operation of an embodiment of the present invention.

### DETAILED DESCRIPTION OF THE PREFERRED EMBODIMENTS

The replication of the DACStore information may be redundant. The present invention may write in one location that may be updated based on a number of triggering events. The present invention may use a storage controller cache to store DACStore type information in one prime (or central) location. The central location may be updated when a DACStore update is initiated. The present invention may store DACStore type information in a cache memory. Such storage may be termed as cStore (Cache Store) which may relate to DACStore type of information stored in cache.

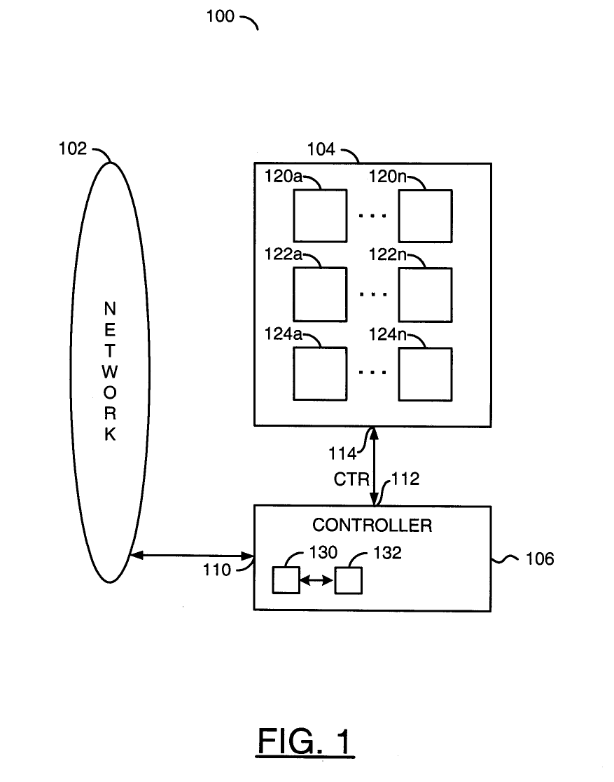

Referring to FIG. 1, a block diagram of a system 100 is shown illustrating a context of the present invention. The system 100 generally comprises a network 102, a block (or circuit) 104, and a block (or circuit) 106. The circuit 104 may be implemented as a number of storage devices (e.g., a storage array). The circuit 106 may be implemented as a controller. In one example, the circuit 106 may be a Redundant Array of Independent Disks (RAID) controller. The network 102 may be connected to an input/output 110 of the controller 106. The controller 106 may have an input/output 112 that may be connected to an input/output 114 of the storage array 104. The controller 106 may include a block (or circuit) 130 and a block (or circuit) 132. The circuit 130 may be implemented as a battery backup unit (BBU). In one example, the circuit 130 may be implemented as a smart battery backup unit. An example of such a smart battery backup unit may be found in co-pending application 61/055,221, filed May 22, 2008, which is hereby incorporated by reference in its entirety. The circuit 132 may be implemented as a persistent storage. In one example, the circuit 132 may be implemented as a Universal Serial Bus (USB) storage device. However, other types of battery backup units and/or storage devices may be implemented to meet the design criteria of a particular implementation.

The storage array 104 may have a number of storage devices (e.g., drives or volumes) 120a-120n, a number of storage devices (e.g., drives or volumes) 122a-122n and a number of storage devices (e.g., drives or volumes) 124a-124n. In one example, each of the storage devices 120a-120, 122a-122n, and 124a-124n may be implemented as a single drive, multiple drives, and/or one or more drive enclosures. In another example, each of the storage devices 120a-120, 122a-122n, and 124a-124n may be implemented as one or more non-volatile memory devices and/or non-volatile memory based storage devices (e.g., flash memory, flash-based solid state devices, etc.).

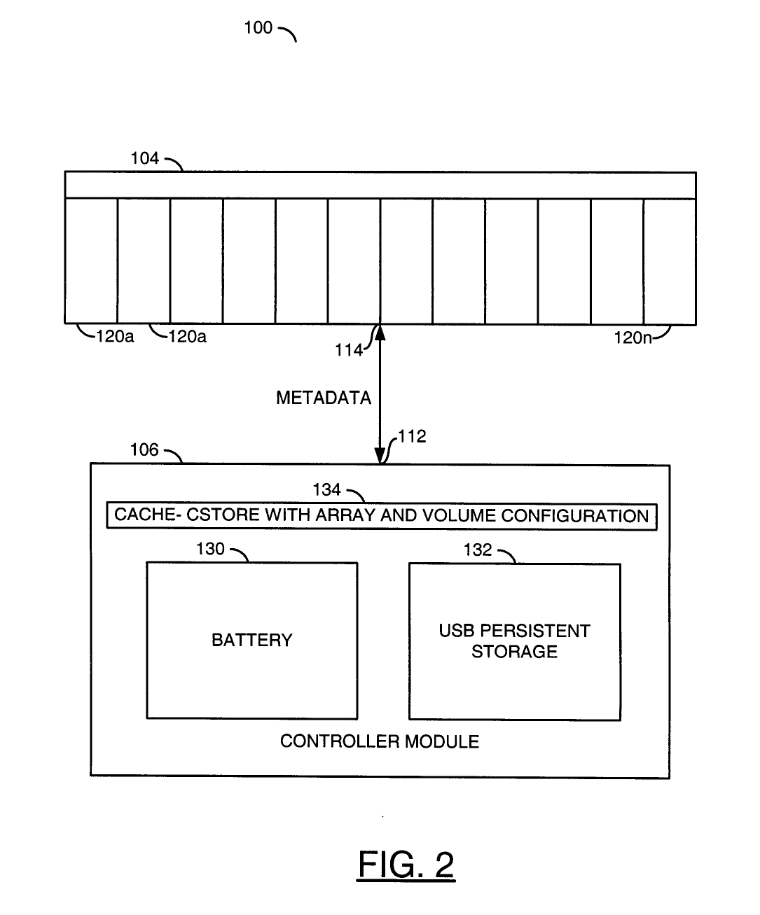

Referring to FIG. 2, a block diagram of the system 100 illustrating more details of the system 100 is shown. The storage array 104 is shown having a number of drives 120a-120n. The drives 120a-120n may be implemented as drive trays each comprising one or more storage devices. The controller 106 may also include a block (or circuit) 134. The circuit 134 may be implemented as a cache circuit.

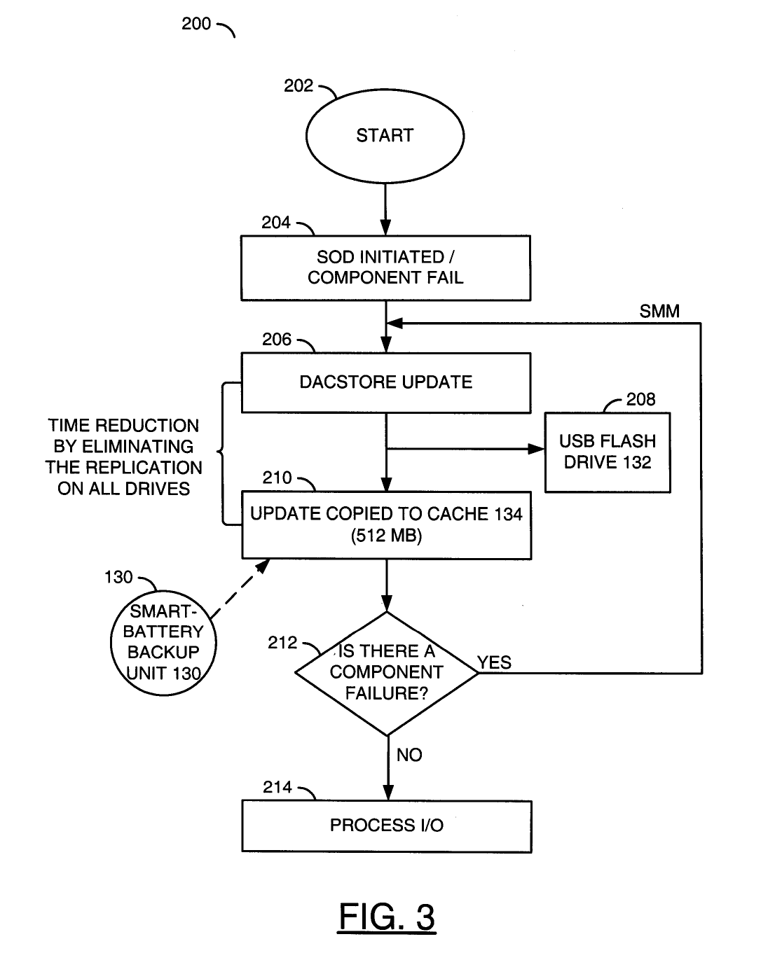

Referring to FIG. 3, a flow diagram illustrating a method (or process) 200 is shown. The method 200 generally comprises a step (or state) 202, a step (or state) 204, a step (or state) 206, a step (or state) 208, a step (or state) 210, a determining step (or state) 212 and a step (or state) 214. The step 202 may start the method 200. The step 204 may initiate the Start of Day procedure. Alternately, the step 204 may start in response to a component failure. The step 206 may initiate a DACstore update. The step 208 may store the DACStore update information to the USB flash drive 132. The step 210 may copy the update to the cache memory 134. The step 210 may be initiated by a signal received from a smart-battery backup unit 130. The step 212 may determine if there is a component failure. If so, then the method 200 returns to the step 206. If not, then the method 200 moves to the step 214. The step 214 may process input/output requests to/from the controller 106.

The system 100 may be used to reduce the boot up time of the controller 106. The system 100 may also increase the performance of the controller 106 and/or the storage array 104. The system 100 may allocate a space in the cache 134 to store information that may be traditionally stored in a DACStore. The system 100 may help to provide faster drive access, reduced boot time, and may use the smart battery features and/or USB backup device features to add robustness and/or availability during power outages. For example, the system 100 may continue to operate under a battery power when the battery backup unit 130 has sufficient battery operating capabilities to run the controller 106. However, the battery backup unit 130 may send a signal to store the configuration information prior to discharging all available power. By delaying the shut down procedures, the system 100 may continue to operate in the event of an intermittent (or short term) power interruption.

The cache circuit 134 may store information traditionally stored as DACStore information in a region inside each of the drives 120a-120n. The cache circuit 134 may store persistent information used by different modules. The DACStore may store information related to (i) arrays, (ii) IP configuration, (iii) volume groups and volumes in the array, (iv) table of volume group, (v) volumes and drive relation, and/or (vi) LUN mapping information. All the assigned drives have same replicated information.

The following are examples of size of the DACStore (e.g., 512 MB for Rev 4): 1 Blk 49 Blks 49 Blks Remaining Portion of 350 MB

The folowing are examples of size of the DACstore (e.g., 512 MB for Rev 4):

| | | | |
|---|---|---|---|
| 1 Blk | 49 Blks | 49 Blks | Remaining Portion of 350 MB |
| SB | Root1 | Root2 | Data |

Capacity may be limited by a subRecord two level directory structure to:

128*128 (dir entries)=16,384 leaf blocks=8 MB per record type.

Max records per type=16,384*(512−4)/record size in bytes. (16,384 max records for 512 byte rec size).

In one example, the cache circuit 134 may be implemented as a 512 MB capacity device. However, other sizes (e.g., 256 MB-1 GB, etc.) may be implemented to meet the design criteria of a particular implementation. The particular size of the cache circuit 134 may be sufficient to store the DACStore information. Although each record type may be limited to 8 MB, each module that uses a record type may create additional types which may increase capacity beyond 8 MB and/or to utilize the full 350 MB of a stable storage sub-system (SSTOR) (or module). The following TABLE 1 illustrates an example of the type of information that may be stored:

TABLE 1
Configuration Database File System Parameters

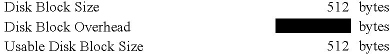

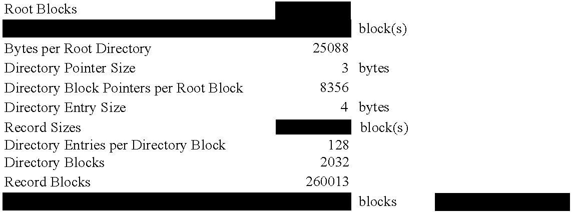

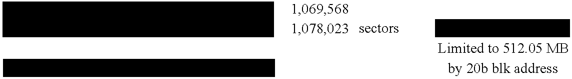

The Stable Storage module may provide a user-friendly interface between the persistent storage device 132 and the file system layer of a hierarchical configuration database. The Stable Storage module may be used by a “transaction file system” to store data records for the SAN related storage devices 120a-120n. An n-way mirror may be implemented on a set of the storage devices 120a-120n. The selected drives 120a-120n may be selected from each drive group (e.g., 120a-120n, 122a-122n, 124a-124n, etc.) and may contain information about the hierarchical configuration database. Multiple drives per group may be selected to provide redundancy in the event of a read failure during a drive group migration.

Several events may affect DACStore information updates, such as (i) controller reboots, (ii) clear configuration—SysWipe, (iii) volume group migration, (iv) new drives addition to volume group, (v) drive failures in volume group, (vi) controller swaps, (vii) array IP modifications, and (viii) drive tray addition.

The system 100 may be used to replace DACStore information normally stored in each of the drives 120a-120n in the cache circuit 134. The cache circuit 134 may contain all the records of the storage array. The cache circuit 134 may reduce the overhead of replicating DACStore data across all of the drives 120a-120n when implementing changes in the storage array 104. The cache circuit 134 may be backed up by the storage device 132 in the storage controller 106. The data may be persistent across reboots as well. The individual drives 120a-120n may not need to have complete DACStore information of the storage array 104. Instead, the cache circuit 134 may be replaced by Metadata which has specific volume configuration information regarding each of the drives 120a-120n. The Metadata information may be updated as a part of the cStore information during volume configuration changes. A common set of configurations may reduce the overhead or complexity involved when modifying the array information. For example, the overhead may be minimized by updating only the volume configuration records for the storage array 104. Generic information may stay intact unless a complete change in the profile of the storage array 104 is needed. In one example, the device 136 may be implemented as a double data rate (DDR) random access memory (RAM). However, other types of memory may be implemented to meet the design criteria of a particular implementation. Access to the memory 134 may be faster than accessing a hard disk drive. A performance improvement in the controller 106 may result. The battery backup unit 130 feature of the current controller modules may make the cStore information persistent. The backup device 132 may ensure availability of the information.

The backup device 132 may be used to maintain Metadata in case of a Power loss (e.g., up to 7 days or more depending on the particular implementation). Redundant Metadata may be saved in the flash and may reduce and/or eliminate the need to replicate such data to all of the drives 120a-120n. Information needed for volume migration may also reside in the cache 134.

The system 100 may have a particular space in the cache circuit 134 allocated to storing the array information and/or the Metadata information. During an event which triggers an update, the system 100 will write only to the cache circuit 134 and process with the SOD sequence. During the SOD sequence, a simultaneous backup of the C-Store information may be implemented. The persistent storage circuit 132 will normally be available even if the smart BBU 130 fails. Without changes to existing hardware and few changes in software, the performance of the SOD sequence may be improved.

When the controller 106 reboots, a device enumeration may be implemented according to usual procedures. Data may be written to the cache 134. The overhead in writing to all of the drives 120a-120n may be removed. Writing to the cache 134 may improve the SOD and/or minimize the boot up time of the controller 106. The device 134 may provide access that is normally faster than the access of the drives 120a-120n.

If storage array configuration is cleared, clearing the cache circuit 134 may only be needed. The volume configuration information/records may be deleted. A link to the Metadata may be broken. The storage array 104 may be cleared quickly, since only the cache circuit 134 may need to be cleared. A replica set of information may normally be maintained in the backup device 132 based on the caching process.

During volume group migration, a software control in a GUI (Graphical User Interface) may be provided to ease the use option to migrate IP information. Options may be provided to select whether to migrate the IP information (or not) and whether the target array is an empty array. Such options may resolve the undesirable effect of having IP conflicts in the same network. Such options may also avoid the pre-requisite of having the source array powered off to avoid IP conflicts when only a few volume groups need to be migrated and the source should still be alive.

Also, while migrating to an empty array without drives, inadvertently importing premium features along with the Metadata in the drives may be avoided. The premium features may also not need to have the generic source array information transferred, since only the volume group information may be migrated. Such migration may prevent the unauthorized transfer of premium features without purchasing such features.

The cStore may be implemented for all types of events triggering a DACStore update, creation, and/or wipe. Time reductions may be implemented with the cStore implementation by eliminating a DACStore in all of the drives 120a-120n. An increase in performance of the write and read to cache (e.g., static RAM) may be faster when compared to disk drives and/or cStore information persistent with smart battery backup units and/or USB backup devices.

The system 100 may (i) array and volume configure information stored in cache (Static RAM—DDR RAM), (ii) a smart battery backup unit (BBU) to cStore data intact during power outages, (iii) a USB backup device to provide additional backup on top of the BBU on complete power fail scenarios.

The system 100 may provide (i) faster storage controller boot up time, (ii) faster access to cache when compared to Hard Disk Drives, (iii) one write required to update changes when compared to multiple writes to update the changes in all drives, (iv) option to the customer to avoid IP conflicts during volume group migration, (v) preventing premium feature hack during volume group migration, (vi) DACStore information persistent as cStore in cache and backed up preventing from dual power outage scenarios, (vii) only software changes required, (viii) no hardware changes required and can be easily implemented with firmware modifications, and/or (ix) simplify the complexity of controller firmware in the area of a Metadata upgrade during SOD.

While the invention has been particularly shown and described with reference to the preferred embodiments thereof, it will be understood by those skilled in the art that various changes in form and details may be made without departing from the scope of the invention.

1. An apparatus comprising:
a storage array comprising a plurality of storage devices;
a controller configured to send one or more commands configured to control reading and writing data to and from said storage array, wherein said commands include volume configuration information used by each of said plurality of storage devices;
a cache storage area within said controller and configured to store a copy of said commands; and
a backup storage area configured to store said copy of said commands during a power failure.

2. The apparatus according to claim 1, wherein said apparatus further comprises a battery backup unit configured to initiate storing of said copy of said commands during said power failure.

3. The apparatus according to claim 2, wherein said battery backup unit provides power to said cache storage area during said power failure.

4. The apparatus according to claim 1, wherein said apparatus reduces a start of day availability time of said array.

5. The apparatus according to claim 1, wherein said volume configuration information comprises a common configuration used by each of said plurality of storage devices.

6. The apparatus according to claim 1, wherein said backup storage area comprises a Universal Serial Bus (USB) storage device.

7. The apparatus according to claim 1, wherein each of said storage devices comprises a drive.

8. The apparatus according to claim 1, wherein each of said storage devices comprises a solid state storage device.

9. An apparatus comprising:
means for implementing a storage array comprising a plurality of storage devices;
means for implementing a controller for sending one or more commands for reading and writing data to and from said storage array, wherein said commands include volume configuration information used by each of said plurality of storage devices;
means for implementing a cache storage area within said controller to store a copy of said commands; and
means for implementing a backup storage area for storing said copy of said commands during a power failure.

10. A method for configuring a plurality of storage devices, comprising the steps of:
(A) implementing a storage array comprising a plurality of storage devices;
(B) implementing a controller configured to send one or more commands configured to control reading and writing data to and from said storage array, wherein said commands include volume configuration information used by each of said plurality of storage devices;
(C) implementing a cache storage area within said controller and configured to store a copy of said commands; and
(D) implementing a backup storage area configured to store said copy of said commands during a power failure.

11. The method according to claim 10, wherein said method further comprises:
configuring a battery backup unit to initiate storing of said copy of said commands during said power failure.

12. The method according to claim 11, wherein said battery backup unit provides power to said cache storage area during said power failure.

13. The method according to claim 10, wherein said method reduces a start of day availability time of said array.

14. The method according to claim 10, wherein said cache storage area stores volume configuration information.

15. The method according to claim 10, wherein said backup storage area comprises a Universal Serial Bus (USB) storage device.

16. The method according to claim 10, wherein each of said storage devices comprises a drive.

17. The method according to claim 10, wherein each of said storage devices comprises a solid state storage device.
